(19) United States
(12) Patent Application Publication
(10) Pub. No.: US 2026/0288249 A1
(43) Pub. Date: Sep. 24, 2026

(54) SYSTEMS, DEVICES, AND METHODS FOR EXTENDED-REALITY SURFACE TYPING

(71) Applicant: Meta Platforms Technologies, LLC, Menlo Park, CA (US)

(72) Inventors: Karol Constantine Hatzilias, Sammamish, WA (US); Jingming Dong, Bellevue, WA (US); Guangxun Liao, San Jose, CA (US); Matthew Douglas Reier, Beaverton, OR (US); Aaron Schmitz, Woodinville, WA (US); Tsz Ho Yu, San Jose, CA (US)

(21) Appl. No.: 19/562,122

(22) Filed: Mar. 10, 2026

Related U.S. Application Data
(60) Provisional application No. 63/775,949, filed on Mar. 21, 2025.

(51) Int. Cl. G06F 3/01; G06F 3/042; G06V 10/12; G06V 20/20; G06V 40/20; H04N 13/239; H04N 23/90

(52) U.S. Cl. CPC G06F 3/017; G06F 3/012; G06F 3/0426; G06V 10/12; G06V 20/20; G06V 40/20; H04N 13/239; H04N 23/90

(57) ABSTRACT

An augmented-reality head-wearable system, includes a first outward-facing camera configured to provide first image data for object tracking, a second outward-facing camera configured to provide second image data for depth sensing, wherein the second outward-facing camera has a higher resolution than the first outward-facing camera, the first outward-facing camera and the second outward-facing camera are configured to provide image data for processing by an artificial intelligence (AI) assistant for contextual AI usage for answering user queries directed to the AI assistant at a first point in time, and the first outward-facing camera and the second outward-facing camera are configured to capture image data associated with a first field-of-view (FOV) of the augmented-reality head-wearable system, and a downward-facing camera, wherein the downward-facing camera is configured to capture gestures within a second FOV of the augmented-reality head-wearable system.

### RELATED APPLICATIONS

This application claims priority to U.S. Prov. App. No. 63/775,949, filed on Mar. 21, 2025, and titled “Systems, Devices, and Methods for Extended-reality Surface Typing,” which is incorporated herein by reference.

### TECHNICAL FIELD

This relates generally to systems, devices, and methods for user interactions with extended-reality wearable systems. In particular, this application relates to systems, devices, and methods that enable surface typing in extended-reality wearable systems.

### BACKGROUND

Mixed-reality devices, systems, and methods need to provide a seamless and immersive extended-reality environment that a user can interact with. Some of the interaction mechanisms are based on gesture recognition, eye-tracking, and/or body-tracking technologies. A notable role in extended-reality applications is to enable more natural and immersive user interaction interfaces with improved gesture recognition, eye-tracking, and/or body-tracking technologies. However, improvements to user interface technologies for wearable extended-reality systems remain challenging due to balancing competing constraints such as form factors, weight, power, efficiency, cost, speed, and/or integration issues with processing speeds, low visual conspicuity of components, and/or seamless user interface features.

As such, there is a need to address one or more of the above-identified challenges. A brief summary of solutions to the issues noted above is described below.

### SUMMARY

Systems, methods, and devices described herein provide reduced form factors, low cost, light weight, and simplified component integration while providing a seamless and more immersive interactive extended-reality environment. As will be discussed in detail herein, visual occlusions from constrained camera positions can be compensated for with optimized camera positioning on a pair of augmented-reality glasses while also reducing visual conspicuity of optical or mechanical components during user interaction with the extended-reality environment.

In one example, an augmented-reality head-wearable system (e.g., an augmented-reality/mixed-reality headset) with a plurality of outward-facing cameras can be used for object tracking and/or contextual artificial intelligence (AI)-assisted user interaction with an augmented-reality environment. In some embodiments, the augmented-reality head-wearable system provides a virtual interface via an augmented-reality surface-typing keyboard. In some embodiments, the virtual interface is an extended-reality keyboard projected onto a physical surface (e.g., a table, wall, flat plane). In some embodiments, the virtual interface is displayed as a floating three-dimensional holographic keyboard in the wearer’s field of view. The extended-reality keyboard can allow the wearer to interact with the virtual keys of the extended-reality keyboard using one or more body movements (e.g., finger motions, gestures) and/or other input devices, such as a stylus or haptic-feedback glove.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive list of electronic devices that can, either alone or in combination (e.g., a system), include instructions that cause the performance of methods and operations associated with the presentation and/or interaction with an XR experience includes an extended-reality headset (e.g., a mixed-reality (MR) headset or an augmented-reality (AR) headset as two examples), a wrist-wearable device, an intermediary processing device, a smart textile–based garment, etc. For example, when an XR headset is described, it is understood that the XR headset can be in communication with one or more other devices (e.g., a wrist-wearable device, a server, intermediary processing device), which together can include instructions for performing methods and operations associated with the presentation and/or interaction with an extended-reality system (e.g., the XR headset would be part of a system that includes one or more additional devices). Multiple combinations with different related devices are envisioned but not recited for brevity.

The features and advantages described in the specification are not necessarily all-inclusive, and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A–1B illustrate different sets of image sensors on a pair of augmented-reality (AR) glasses, each of which are used for different functions for interacting with an extended-reality environment (e.g., a classroom with AR enhancements), in accordance with some embodiments.

FIGS. 2A–2B illustrate how the first sensor is used to perform face tracking for controlling facial movements of an avatar in a video call, in accordance with some embodiments.

FIG. 3 shows an example pair of AR glasses 100 that illustrates approximate placement of different sensor suites, in accordance with some embodiments.

FIGS. 4A, 4B, 4C-1, and 4C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user’s physical surroundings. Such MRs can include and/or represent virtual realities (VRs) in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended-reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive, and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interaction with these AR and MR environments described herein can occur using multiple different modalities, and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and/or other gestures that can be detected and determined based on movements of a single hand (e.g., a one-handed gesture performed with a user’s hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user’s hand does not contact a surface, object, or portion of an electronic device (e.g., a head-wearable device or other communicatively coupled device, such as the wrist-wearable device); in other words, the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user’s hand or another finger, on the user’s leg, a couch, and/or a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user’s possession (e.g., smartphones, laptops, imaging devices, intermediary devices, and/or other devices described herein).

The input modalities as alluded to above can be varied and are dependent on a user’s experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting, and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)) is an electronic component that is responsible for executing instructions and controlling the operation of an electronic device (e.g., a wrist-wearable device, a head-wearable device, a handheld intermediary processing device (HIPD), a smart textile–based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, “memory” refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid-state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, and other non-volatile solid-state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user’s heart rate; (v) peripheral oxygen saturation (SpO2) sensors for measuring blood oxygen saturation and/or other biometric data of a user; (vi) capacitive sensors for detecting changes in potential at a portion of a user’s body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user’s environment. As described herein, biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; and (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage mediums that can be used to store electronic data in a non-transitory form (e.g., such that the data is stored permanently until it is intentionally deleted and/or modified).

### Forward-Facing and Downward-Facing Camera Systems

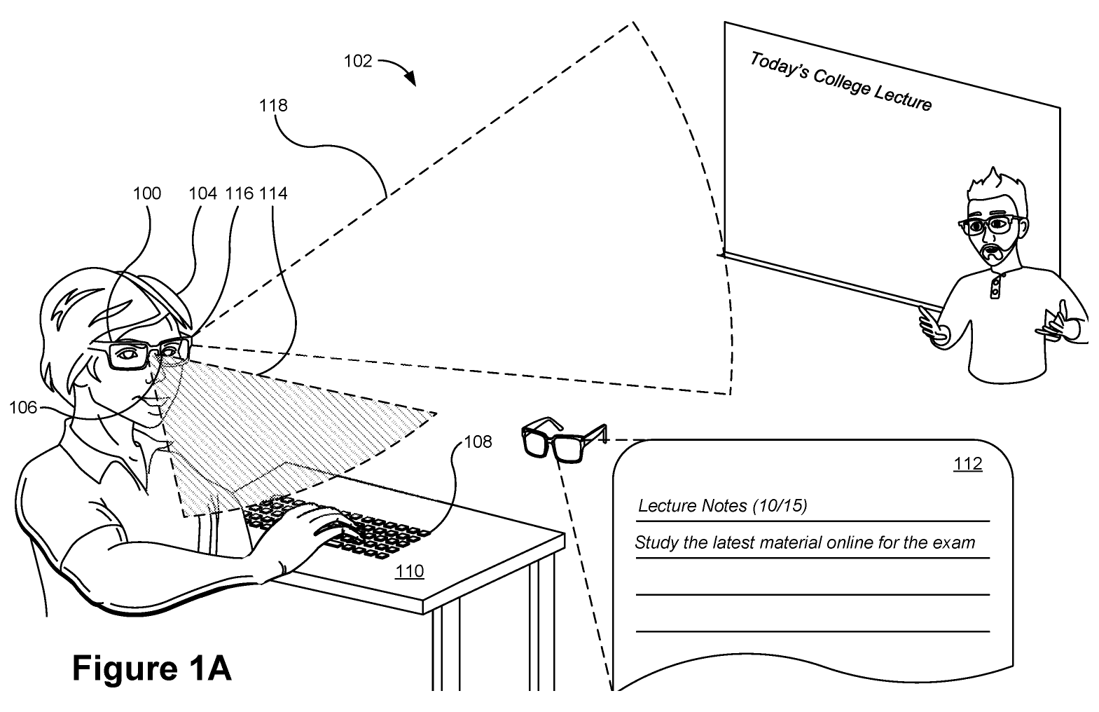

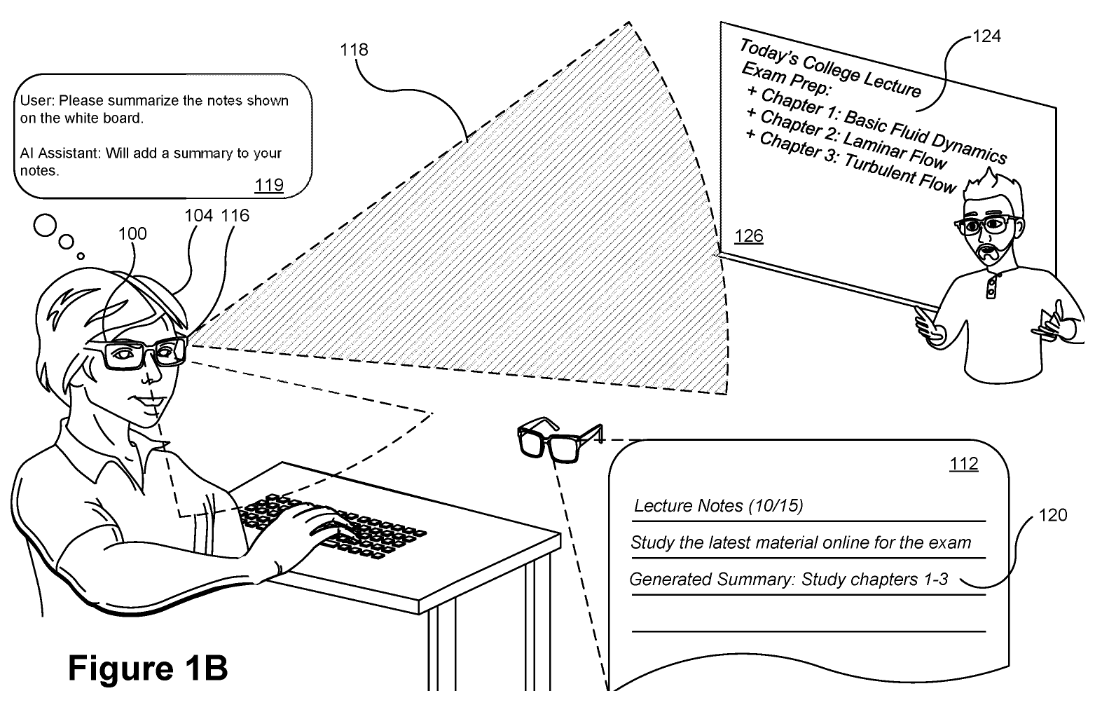

FIGS. 1A–1B illustrate different sets of image sensors on a pair of augmented-reality (AR) glasses 100, each of which is used for different functions for interacting with an extended-reality environment 102 (e.g., a classroom with AR enhancements), in accordance with some embodiments. FIG. 1A shows the user 104 wearing a pair of AR glasses 100 in an extended-reality environment 102 (e.g., a classroom), and the pair of AR glasses 100 are configured to perform different operations using different image sensors. In some embodiments, the image sensors have different fields of view, and in other embodiments, the sensor or sensors (e.g., RGB image sensors, SLAM cameras) are configured to have a wide field of view. In this example, a first sensor (or sensors) has a first field of view (FOV) 114 that is downward-facing and that focuses on tracking input movements. In an alternative embodiment, a single camera or binocular cameras can have a wide field of view that spans a forward-facing FOV and a downward-facing FOV. In some embodiments, the wide field of view is separated into a forward-facing section and a downward-facing section, wherein the forward-facing section is used for providing contextual information to an AI assistant, and the downward-facing section is used for tracking facial movement, lower body movements, hand tracking, and various other tasks.

The first sensor (or sensors) is used for tracking facial movement and lower body movements (e.g., limb movements, hand/finger movements). In this example, the first sensor 106 is used for hand tracking, and the tracked hand movements are used to determine which inputs are provided to an AR keyboard 108 that is superimposed on a surface 110. In other words, the keyboard is displayed on a display of the pair of AR glasses 100 when the user looks down to where the keyboard 108 is placed. In some embodiments, the keyboard can be placed on any suitable surface, either by a selection by the user 104 or automatically by the pair of AR glasses 100. In some embodiments, hand tracking can be used for various tasks, such as using a trackpad, tracking hand movements to provide contextual information through an AI assistant (e.g., cooking instructions), hand gestures for performing operations, etc.

In response to the data recorded by the first sensor indicating keystrokes have been received, the long-form input (e.g., sentences) is inputted into an application (e.g., a notepad application 112) displayed on the pair of AR glasses. In some embodiments, the first sensor indicates a keystroke has been performed by recognizing a hand gesture of the user 104 (e.g., a finger tap) over the surface 110 that the AR keyboard 108 is superimposed on. In some embodiments, other hand gestures such as pinches (e.g., digit to digit contact), zooms (e.g., moving from digit-to-digit contact to non-contact), swipes, and other gestures are recognized as user inputs when performed over the surface 110. While a keyboard is shown as being the virtual input device, other virtual input devices can be used, such as virtual mouse inputs, hand and/or finger movement inputs, finger drawing inputs, sign language inputs, etc. While a notepad application is shown, any other suitable app that can receive long-form inputs (e.g., a messaging application, a social media application) is conceivable. In some embodiments, an eye sensor tracks eye movements of the user 104 and recognizes user inputs based on the eye movements. In some embodiments, eye movements are used in conjunction with other virtual inputs to perform certain operations (e.g., copying and pasting certain text within the first FOV 114 of the user 104).

In some embodiments, the AI assistant modifies the size, position, and/or keyboard layout (e.g., QWERTY, Dvorak) of the AR keyboard 108 based on settings configured by user 104. In some embodiments, the AR keyboard 108 is modified based on the eye position of user 104 such that the AR keyboard 108 is centered within the first FOV 114 of the user 104 while the user 104 is looking down at the AR keyboard 108. In some embodiments, the size of the AR keyboard 108 changes based on the hand size of the user 104. In some embodiments, the user 104 can remap and/or rearrange keys on the AR keyboard 108.

In some embodiments, if surface 110 is curved, irregular, or otherwise not shaped rectangularly, the AR glasses 100 can provide an indication to the user 104 to select a different surface from surface 110 on which to superimpose AR keyboard 108. In some embodiments, the AI assistant can determine, based on image data in first FOV 114, an optimal surface on which to superimpose AR keyboard 108.

FIG. 1B illustrates a second sensor being relied upon to facilitate a verbal request to an artificially intelligent (AI) assistant to perform an operation, in accordance with some embodiments. In this example, a second sensor (or sensors) 116 has a second FOV 118 that is different from the first FOV 114. In this example, the second sensor 116 is outward-facing FOV as opposed to the downward-facing FOV of the first sensor. In some embodiments, the fields of view overlap with each other.

As shown, the second sensor 116 is used for providing image data that is processed (e.g., object detection, text detection) to provide contextual information to an AI assistant. In this example, the user 104 is querying the AI assistant (illustrated in conversation bubble 119) to perform an operation that necessitates contextual information. In response to the query, the AI assistant provides a summary 120 in the notepad application 112, where the summary is produced in part by contextual information harvested from the image data (e.g., that includes text 124 on a whiteboard 126) captured by the second sensor 116 (e.g., processing and summarizing text shown on whiteboard 126). In some embodiments, the text 124 is in a language different from the language the user 104 prefers and/or the language the AR glasses 100 are configured to be in, and the AI assistant provides a translated version of text 124 when providing the summary 120 in the notepad application 112. In some embodiments, the user AI assistant attempts to perform one or more tasks in response to the query based on image data captured by a first outward-facing camera of the second sensor. In some embodiments, if the AI assistant determines that the image data captured by the first outward-facing camera is not sufficient to respond to the query, the AI assistant causes a second outward-facing camera of the second sensor 116 to capture image data to respond to the query. In some embodiments, the second outward-facing camera captures image data that is a higher resolution than the image data captured by the first outward-facing camera. In some embodiments, the second outward-facing camera is capable of capturing image data at a higher frame rate than the first outward-facing camera. In some embodiments, both the image data captured by the first outward-facing camera and the image data captured by the second outward-facing camera are used by the AI assistant to respond to the query.

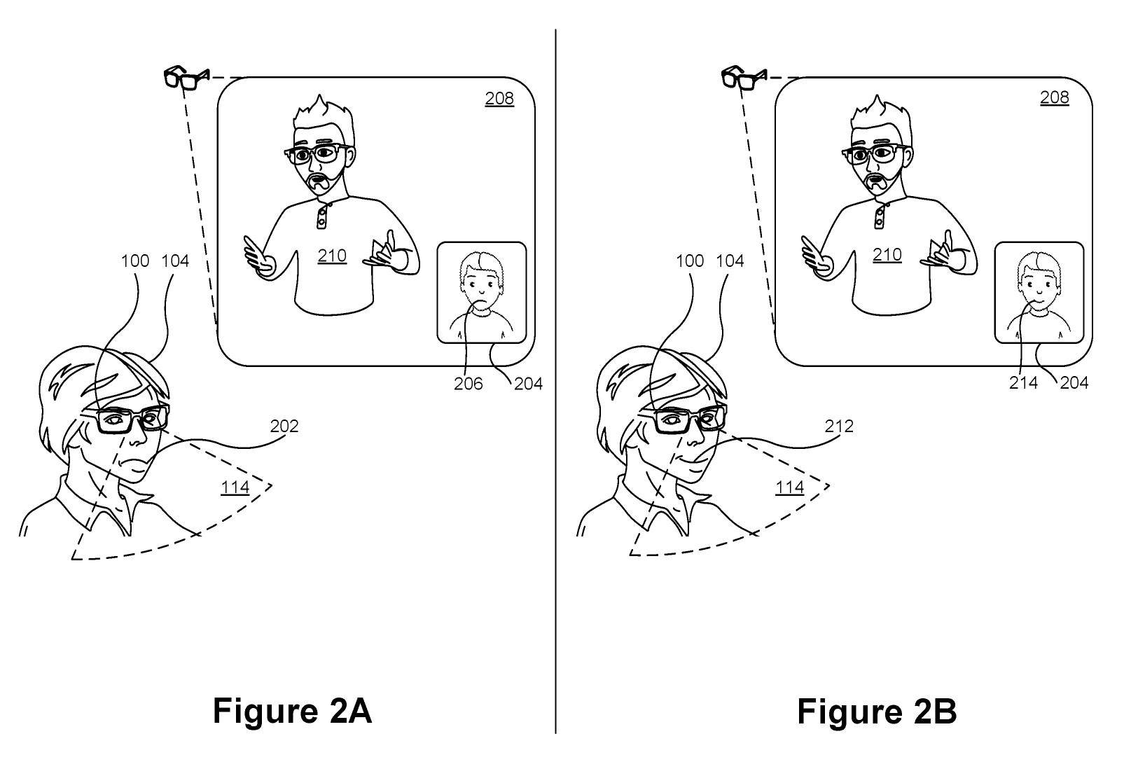

FIGS. 2A–2B illustrate how the first sensor is used to perform face tracking for controlling facial movements of an avatar in a video call, in accordance with some embodiments. FIG. 2A shows a pair of AR glasses 100 being worn by user 104 and a first sensor (or sensors) that has the first FOV 114. The first sensor is further configured to track facial movements (e.g., jawline movement, lip movement, and other facial feature movement) of the user 104. The tracked facial movements can be used to control facial movements of an avatar that can be used to represent the user 104, for example, in a video call or an XR environment.

In particular, FIG. 2A shows user 104 having a frown 202, which is within the first FOV 114. In response to the frown 202 being recognized, the avatar 204 is updated to reflect the frown 202 by including a virtual frown 206. The avatar 204 is updated in real time such that the user’s facial expressions are matched with avatar’s facial expression without delay (e.g., without a human perceptible delay, such as less than 100ms delay). An example AR interface 208 is shown to the user that includes the avatar 204 and another user 210 with which the user 104 is communicating.

FIG. 2B shows the user 104 no longer having a frown and now smiling 212, which is also within the FOV 114. In response to the smile 212 being recognized, the avatar 204 is updated to reflect the smile 212 by including a virtual smile 214.

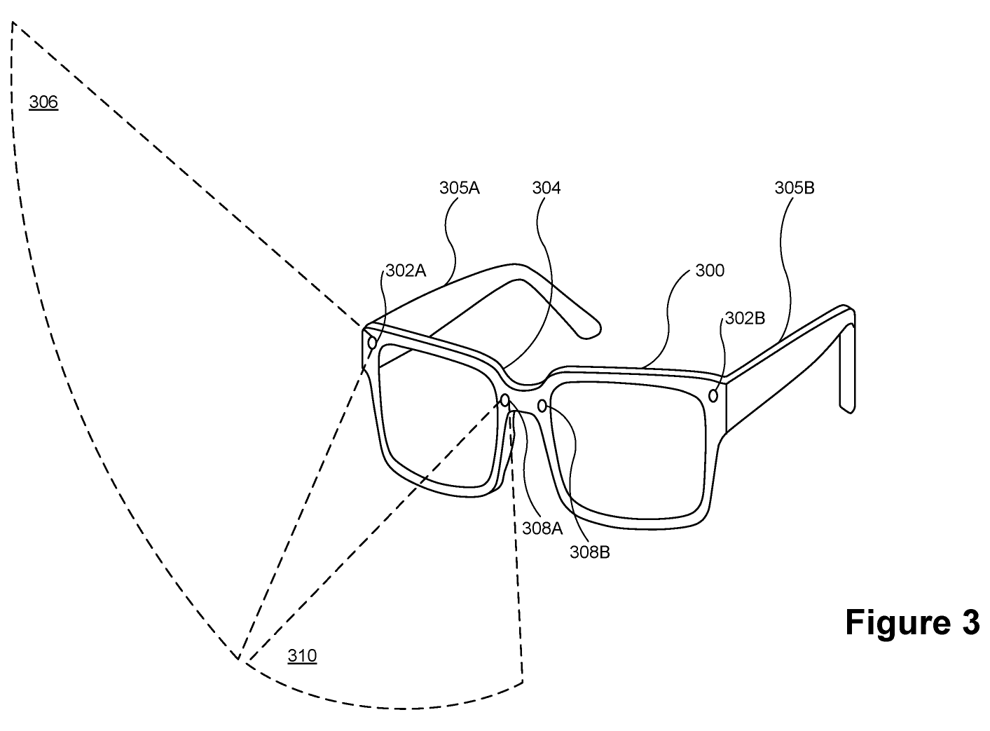

FIG. 3 shows AR glasses 300 (which in some embodiments, are analogous to AR glasses 100 shown in FIGS. 1A-1B and 2A-2B) that illustrate approximate placement of different sensor suites, in accordance with some embodiments. FIG. 3 shows a first suite of sensors (302A and 302B) located on outer portions of the lens frame 304 near the temple arms (305A and 305B), which have an FOV of a first angle 306 (e.g., first FOV 114; FIG. 1A). In some embodiments, the sensors 302A and 302B are the same sensor type. In some embodiments, the sensors 302A and 302B are different types of sensors with different features and FOVs. For example, (i) one of the sensors can be a computer vision sensor with a first resolution and a first FOV that is used for object tracking and (ii) the other sensor can be a second resolution that is higher than the first resolution and a second FOV that is narrower than the first FOV and that is used for contextual AI. In some embodiments, the sensors 302A and 302B are the first outward-facing camera and the second outward-facing camera described with respect to FIG. 1B. In some embodiments, a dual-purpose sensor (e.g., an RGB sensor) can be used, in which the dual-purpose sensor is configured to be used as a contextual AI sensor but is also able to retrieve a mono image (i.e., a monochrome image) intermittently for use in depth sensing (e.g., by utilizing stereo matching, structured light, time-of-flight, and any other suitable depth–sensing techniques) in conjunction with another computer vision sensor.

FIG. 3 also shows a second suite of sensors (308A and 308B) located on a nose pad portion or nose bridge portion of the lens frame 304, which have an FOV of a second angle 310 (e.g., second FOV 118). The FOV of a second angle 310 is downward-facing, such that the FOV of a second angle 310 captures at least hand movements and facial movements of a user. It can also be used for any other task that would occur in the FOV of a second angle (e.g., cooking directions, providing information for contextual assistance).

In one example, the two outward-facing cameras (e.g., the sensors that are not facing downward) comprise two different types of outward-facing cameras (i.e., sensors 302A and 302B). For example, one of the outward-facing cameras can be a computer vision camera (sensor) for object tracking, which in some embodiments may have a lower resolution and a wide FOV. The other outward-facing camera can have a higher resolution with a narrower FOV (as compared to the wide FOV) camera for supporting contextual AI features. In some embodiments, the other outward-facing camera only activates upon a determination that the image data captured by the first outward-facing camera is not able to be analyzed to respond to a user query. In some embodiments, a user query is received by the AR glasses 100 (e.g., the user 104 verbally asks a question about one or more objects in the field of view of the user 104). In response to the user query, image data from the first outward-facing camera is analyzed by the AI assistant. In accordance with a determination by the AI assistant that the image data from the first outward-facing camera is not sufficient to respond to the user query, the second outward-facing camera with the higher resolution captures other image data that is analyzed by the AI assistant to generate a response to the user query. In some embodiments, a response to the user query is generated by the AI assistant based on one of the image data and the other image data. In some embodiments, the response is further generated by the AI assistant based on one or more gestures of the user 104 based on downward image data captured by the one or more downward-facing cameras. For example, if the user 104 is frowning when they ask their question (e.g., “Why is this lecture so difficult?”), the AI assistant may generate a response that goes into detail about the contents of the user’s field of view (e.g., describing the concepts on a whiteboard with clear-cut examples of how the concepts are applied). As another example, if the user 104 is smiling, relaxed, or unstressed when they ask their question (e.g., “Why is this lecture so difficult?”) the AI assistant may generate a response that prompts the user 104 to decide whether they want more detail about the contents of the field of view of the user 104 (e.g., providing the user the option of whether to go into more detail about the concepts on a whiteboard now, if they want a summary now, or if they want more detail about the concepts at a later point in time). In some embodiments, by activating the second outward-facing camera only when necessary to respond to a user query, power can be conserved at the system and computing resources can be allocated to other functions of the AR glasses 100.

In some embodiments, the second outward-facing camera is configured to have a dual purpose of (i) providing image information to the contextual AI system and (ii) pulling (i.e., retrieving, copying, or otherwise acquiring) a mono image every few frames for use in depth sensing. In some embodiments, the mono image is pulled every frame. In some embodiments, the mono image is pulled at a pre-defined number of frames. In some embodiments, the second outward–facing camera is a red-blue-green (RGB) camera. In some embodiments, the second outward–facing camera is an infrared camera for tracking objects in low-light conditions. Due to the dual purposing of the other camera to also be able to provide depth-sensing information, an extra computer vision camera is not required. In some embodiments, the second outward-facing camera is also used as a traditional camera for capturing photographs/video at the request of the user 104 or as directed by one or more applications of the AR head-wearable system and/or another device communicatively coupled to the AR head-wearable system.

In some embodiments, the first outward-facing camera and the second outward-facing camera have specific frame rates, lens characteristics (e.g., focal lengths, apertures), and/or resolutions for different scenarios. For example, the outward-facing cameras can use RGB sensors for object tracking in normal light conditions, and infrared sensors for object tracking in low-light conditions. In some embodiments, the settings of the first outward-facing camera and the second outward-facing camera are based on the depth sensed from the retrieved mono image. In some embodiments, only the first outward-facing camera is active for the purpose of providing image information to the contextual AI system, and the second outward–facing camera activates upon a determination that high-resolution image data is necessary to perform a task (e.g., the user 104 performs a user query directed at the AI assistant that the AI assistant determines requires high-resolution image data to effectively respond to).

The two downward-facing cameras are configured to track whether a wearer’s jawline is moving, which can be used to infer mouth opening and closing of the wearer. In some embodiments, this information can be used in aiding presentation of an avatar representing the wearer by causing lip movement during video calls with others. The downward-facing cameras can detect movement of other portions of the wearer’s body to better aid in presenting an avatar. For example, the downward cameras can be configured to detect head movement alone, head and shoulder movements together, legs, arms, torso, feet, etc. As mentioned elsewhere, hand tracking can also be used for hand gesture tracking and surface typing as well. In some embodiments, the outward-facing cameras can be configured to detect head, shoulder, legs, arms, torso, feet, and any other movements of body parts.

In some embodiments, a first downward-facing camera of the two downward-facing cameras has a first occlusion region corresponding to a location of the first downward-facing camera on a frame (e.g., lens frame 304), and a second downward-facing camera of the two downward-facing cameras has a second occlusion region corresponding to a location of the second downward-facing camera on the frame (e.g., lens frame 304). In some embodiments, the first downward-facing camera and the second downward-facing camera provide stereo vision coverage for the second FOV by subtracting the first occlusion region and the second occlusion region (e.g., to avoid hair, hand, and/or body occlusion). In some embodiments, a predictive algorithm tracks objects (such as fingers, the AR keyboard 108, etc.) while they are occluded. In some embodiments, the predictive algorithm estimates the stereo vision coverage for the second FOV.

In some embodiments, each imaging device has an FOV angle in the range of 60 degrees to 120 degrees. In some embodiments, the exact placement of the cameras is adjustable depending on the design constraints of the lens frame they are installed on.

In light of these principles, we now turn to certain embodiments.

(A1) In accordance with some embodiments, an AR head-wearable system with an extended-reality surface-typing system is described herein. In some embodiments, the AR head-wearable system has a first outward-facing camera configured to provide first image data for object tracking; a second outward-facing camera configured to provide second image data for depth sensing (e.g., by retrieving mono frames). In some embodiments, the second outward-facing camera has a higher resolution than the first outward-facing camera, the first outward-facing camera and the second outward-facing camera are configured to provide image data for processing by an artificial intelligence (AI) assistant for contextual AI usage for answering user queries directed to the AI assistant at a first point in time, and the first outward-facing camera and the second outward-facing camera are configured to capture image data associated with a first FOV of the AR head-wearable system, and a downward-facing camera configured to capture gestures within a second FOV of the AR head-wearable system. For example, FIGS. 1A–3 illustrate an AR head-wearable system that includes outward–facing cameras used for object tracking and for providing contextual information for an AI model. As shown in FIG. 1A, the AR glasses 100 include a first sensor 106 and a second sensor 116, where the second sensor 116 captures image data within the second FOV 118 for processing by an AI assistant to provide contextual information such as summarizing text 124 displayed on whiteboard 126 as illustrated in FIG. 1B. FIG. 3 further illustrates the placement of first sensor 302A and second sensor 302B on the lens frame 304 near temple arms 305A and 305B, with a first angle 306 representing the outward-facing field of view.

(A2) In some embodiments of A1, the second outward-facing camera only provides the second image data to the AI assistant upon receiving, from a wearer of the AR head-wearable system, a query regarding an object in the first image data, and determining that the AI assistant cannot answer the query based on only the first image data. For example, FIG. 1B shows a user 104 requesting 119 an AI assistant to summarize text 124 displayed on whiteboard 126, where second sensor 116 captures image data within the second FOV 118 for processing by the AI assistant to complete the user request 119, and proceeds to generate summary 120 displayed in notepad application 112. FIG. 3 further illustrates the placement of first sensor 302A and second sensor 302B on the lens frame 304 near temple arms 305A and 305B, with a first angle 306 representing the outward-facing field of view.

(A3) In some embodiments of A1–A2, a response to the user queries is generated by the AI assistant based on the second image data and one or more gestures of the wearer captured by the downward-facing camera. For example, FIGS. 2A–3 show downward-facing cameras being used for many operations, including tracking keystrokes on an AR keyboard. As illustrated in FIG. 1A, the first sensor 106 has a first FOV 114 that is downward-facing and captures the AR keyboard 108 superimposed on surface 110, enabling the user 104 to perform surface typing. FIG. 3 shows the downward-facing sensor 308A and downward-facing sensor 308B positioned on the nose pad portion of the lens frame 304, with a second angle 310 oriented to capture hand movements and facial movements of the wearer.

(A4) In some embodiments of any one of A1–A3, one or more of the first outward-facing camera, the second outward-facing camera, and the downward-facing camera are configured to detect head and shoulder movements of the wearer of the head-wearable system. For example, FIGS. 2A–2B show an example in which the downward-facing cameras can be used to track head movements, such as facial expressions. As illustrated in FIGS. 2A-2B, the first FOV 114 captures the frown 202 and smile 212 of the user 104, which are used to update the avatar 204 with corresponding virtual frown 206 and virtual smile 214 in the AR interface 208 during communication with another user 210.

(A5) In some embodiments of any one of A1–A4, the downward-facing camera is configured to track waist and chest movements of the wearer of the head-wearable system. For example, the discussion pertaining to FIGS. 2A–2B describes examples in which the downward-facing cameras can be used to track other movements besides facial expressions (e.g., hand movement for gestures, body movements). As shown in FIG. 3, the downward-facing sensor 308A and downward-facing sensor 308B have a second angle 310 that enables capture of body movements within the downward-facing field of view. Additionally, FIGS. 4C-1 and 4C-2 illustrate how the MR system 400c tracks body movements of user 402 to update the MR representation of user 422 within the MR game environment 420.

(A6) In some embodiments of any one of A1–A5, the downward-facing camera is configured to track jawline and/or lip movements of the wearer of the head-wearable system. For example, FIGS. 2A–2B show an example in which the downward-facing cameras can be used to track facial expressions, either directly or inferred from other movements within the FOV. As illustrated in FIG. 2A, the first FOV 114 captures the frown 202 of user 104, and in FIG. 2B, the first FOV 114 captures the smile 212, with both expressions being reflected in real time on the avatar 204 displayed in the AR interface 208.

(A7) In some embodiments of any one of A1–A6, the downward-facing camera is communicatively coupled to one or more display projectors that cause display of an extended-reality keyboard within the second FOV based on the gestures captured by the downward-facing camera. For example, FIG. 1A illustrates a virtual keyboard 108 in which the AR glasses 100 are configured to track hand movements. As shown in FIG. 1A, the first FOV 114 of the first sensor 106 captures hand movements of the user 104 over the surface 110 where the AR keyboard 108 is superimposed, enabling keystroke recognition for input into the notepad application 112.

(A8) In some embodiments of any one of A1–A7, the downward-facing camera is a first downward-facing camera, and the system further has a second downward-facing camera. In some embodiments, the first downward-facing camera has a first occlusion region corresponding to a location of the first downward-facing camera on the wearable frame, the second downward-facing camera has a second occlusion region corresponding to a location of the second downward-facing camera on the wearable frame, and the first downward-facing camera and the second downward-facing camera provide stereo vision coverage for the second FOV by subtracting the first occlusion region and the second occlusion region from the second FOV of the head-wearable system. In some embodiments the first downward-facing camera and the second downward-facing camera provide stereo vision coverage for a third FOV, distinct from the second FOV, by subtracting the first occlusion region and the second occlusion region from the second FOV of the head-wearable system. For example, FIG. 3 illustrates the AR glasses 300 with downward-facing sensor 308A and downward-facing sensor 308B positioned on the nose bridge portion of the lens frame 304, with each sensor having a respective occlusion region based on its location, and together providing stereo vision coverage within the second angle 310.

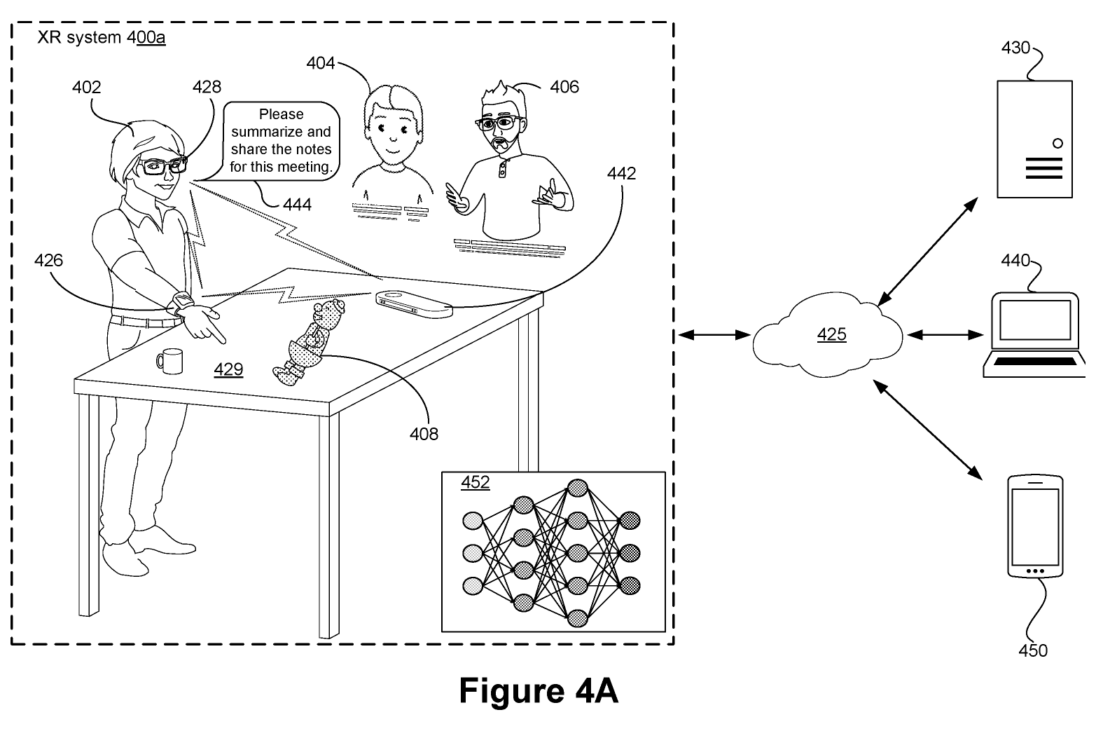

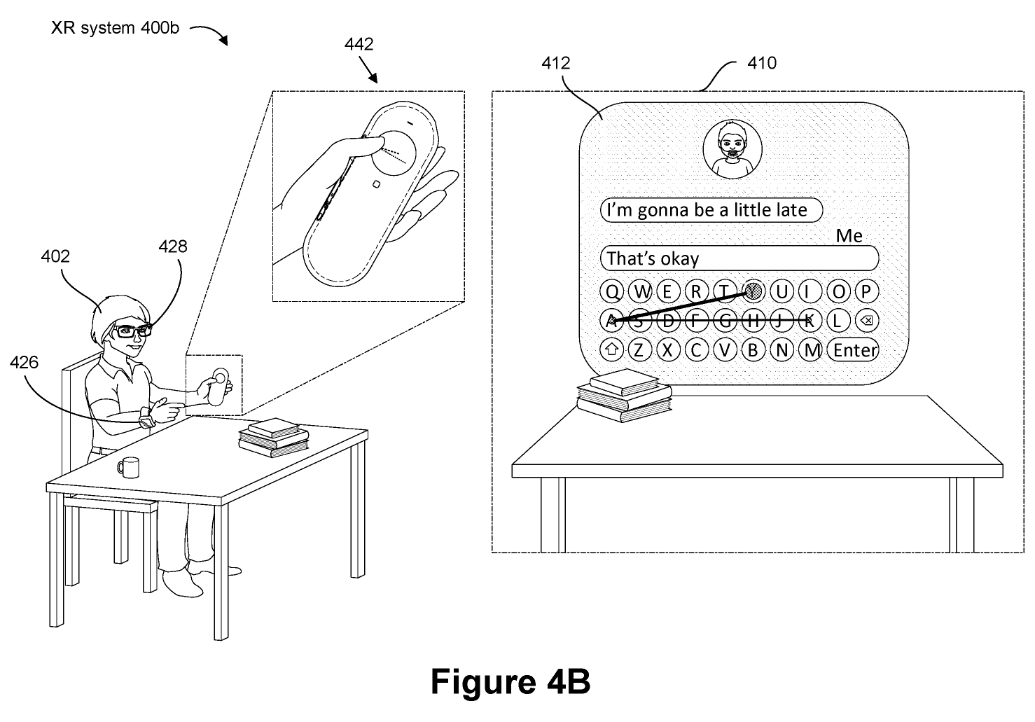

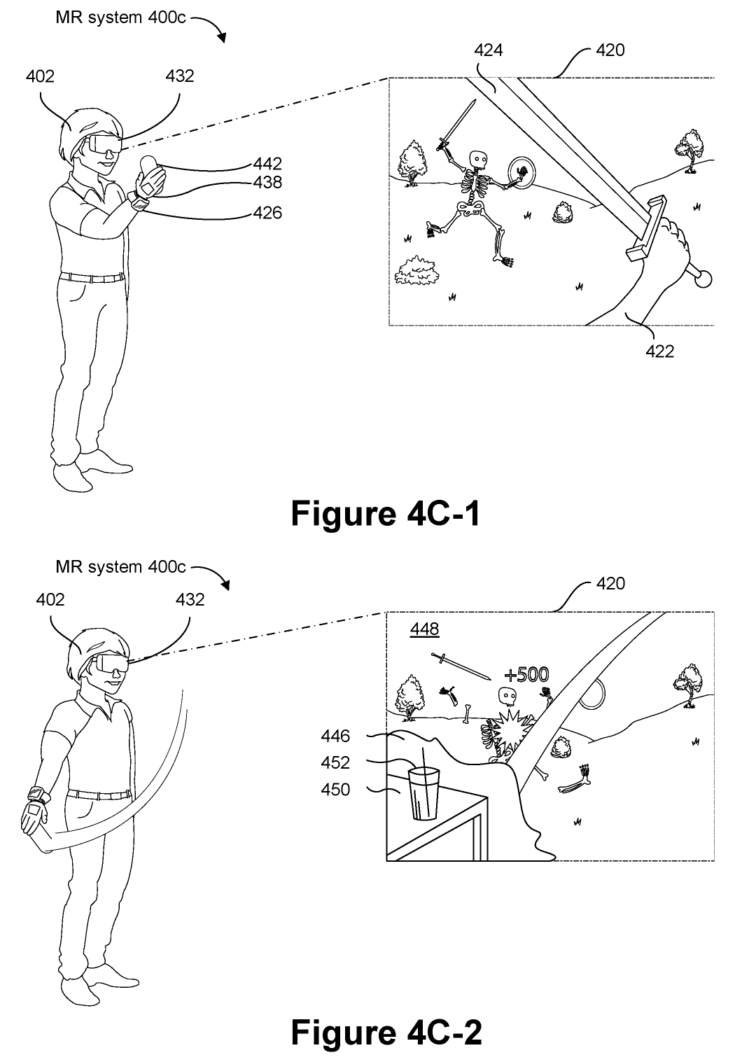

(A9) In some embodiments of any one of A1–A8, the AR system further has a first lens mounted in the wearable frame and a second lens mounted in the wearable frame. The first lens and the second lens are optically transmissive to visible light and include display circuitry (e.g., display engines) for projecting contextual AR information based on the image data of the first FOV of the head-wearable system. For example, FIGS. 1A and 1B show an AR keyboard 108 that is visible to the user 104 due to display projector assemblies within the AR glasses. Further discussion of how the AR glasses function is provided in the discussion pertaining to FIGS. 3 and 4A-4C. As shown in FIG. 4A, the AR device 428 presents virtual objects 408, avatar 404, and digital representation of contact 406 to user 402 through transparent lenses, while the user 402 can also directly view physical objects such as physical table 429. FIG. 4B further illustrates the AR device 428 presenting the messaging user interface 412 within the field of view 410 of user 402.

(A10) In some embodiments of any one of A1–A9, the downward-facing camera is communicatively coupled to the one or more display engines (e.g., display circuitry), and the one or more display engines cause display of an extended-reality keyboard within the second FOV based on the gestures captured by the downward-facing camera. For example, as illustrated in FIG. 1A, the first sensor 106 captures gestures within the first FOV 114, and the AR glasses 100 display the AR keyboard 108 superimposed on surface 110, with keystrokes being recognized and input into the notepad application 112.

(A11) In some embodiments of any one of A1–A10, the AR system further has a surface-typing system located on the wearable frame and communicatively coupled to the one or more display engines, the first outward-facing camera, the second outward-facing camera, and the downward-facing camera. For example, FIG. 1A illustrates the AR glasses 100 with a surface-typing system that enables the user 104 to interact with the AR keyboard 108 on surface 110, with the first sensor 106 tracking hand movements within the first FOV 114 and the second sensor 116 providing contextual information within the second FOV 118.

(A12) In some embodiments of any one of A1–A11, the AR system is configured to continue tracking keystroke gestures for the extended-reality keyboard within the second FOV when the first FOV of the head-wearable system has changed to a third FOV of the head-wearable system, the third FOV has no overlap with the second FOV, and the first FOV has an overlap with the second FOV. For example, the extended-reality keyboard is world locked and the AR system continues to track hand gestures and/or other types of user gestures via input devices (e.g., a stylus, haptic device). As illustrated in FIG. 1A, the AR keyboard 108 remains superimposed on surface 110 within the first FOV 114 even as the user 104 may shift their gaze toward the extended-reality environment 102 captured by the second FOV 118.

(A13) In some embodiments of any one of A1–A12, the overlap of the first FOV with the second FOV includes the extended-reality keyboard region. As described in reference to FIG. 3, it is possible that the sensor systems can be configured to overlap with each other. For example, FIG. 3 shows the first angle 306 of the outward-facing sensors (302A, 302B) and the second angle 310 of the downward-facing sensors (308A, 308B), which may be configured to have overlapping coverage regions to ensure continuous tracking of the AR keyboard and user gestures.

(B1) In accordance with some embodiments, a method of assembling an AR system includes forming an imaging system that has a first outward-facing camera configured to provide first image data for object tracking; a second outward-facing camera configured to provide second image data for depth sensing (e.g., by retrieving mono frames). In some embodiments, the second outward-facing camera has a higher resolution than the first outward-facing camera, the first outward-facing camera and the second outward-facing camera are configured to provide image data for processing by an artificial intelligence (AI) assistant for contextual AI usage for answering user queries directed to the AI assistant at a first point in time, and the first outward-facing camera and the second outward-facing camera are configured to capture image data associated with a first FOV of the AR head-wearable system, and a downward-facing camera configured to capture gestures within a second FOV of the AR head-wearable system. For example, FIG. 3 illustrates the AR glasses 300 with first sensor 302A and second sensor 302B positioned on the lens frame 304 near temple arms 305A and 305B, with the first angle 306 representing the outward-facing field of view for object tracking and contextual AI processing. As shown in FIG. 1B, the second sensor 116 captures image data within the second FOV 118 for processing by an AI assistant to provide contextual information such as summarizing text 124 displayed on whiteboard 126.

(B2) In some embodiments of B1, the AR system of B1 is configured in accordance with any one of A1–A13.

(C1) In accordance with some embodiments, a non-transitory computer-readable storage medium storing instructions, which, when executed by an AR head-wearable system that includes an apparatus and one or more processors, cause the one or more processors to perform a set of operations, including providing, from a first outward-facing camera, first image data for object tracking, and providing, from a second outward-facing camera, second image data for depth sensing. The second outward-facing camera has a higher resolution than the first outward-facing camera, the first outward-facing camera and the second outward-facing camera are configured to provide image data for processing by an artificial intelligence (AI) assistant for contextual AI usage for answering user queries directed to the AI assistant at a first point in time, and the first outward-facing camera and the second outward-facing camera are configured to capture image data associated with a first FOV of the AR head-wearable system, and capturing, from a downward-facing camera, gestures within a second FOV of the AR head-wearable system. For example, FIGS. 1A–3 illustrate an AR head-wearable system that includes outward facing cameras used for object tracking and for providing contextual information for an AI model. As shown in FIG. 1A, the AR glasses 100 include a first sensor 106 and a second sensor 116, where the second sensor 116 captures image data within the second FOV 118 for processing by an AI assistant.

(C2) In some embodiments of C1, the AR head-wearable system of C1 is configured in accordance with the AR system of any one of A1–A13.

### Example Extended-Reality Systems

FIGS. 4A, 4B, 4C-1 and 4C-2 illustrate example XR systems that include AR and MR systems, in accordance with some embodiments. FIG. 4A shows a first AR system 400a and first example user interactions using a wrist-wearable device 426, a head-wearable device (e.g., AR device 428), and/or a HIPD 442. FIG. 4B shows a second XR system 400b and second example user interactions using a wrist-wearable device 426, AR device 428, and/or an HIPD 442. FIGS. 4C-1 and 4C-2 show a third MR system 400c and third example user interactions using a wrist-wearable device 426, a head-wearable device (e.g., an MR device such as a VR device), and/or an HIPD 442. As the skilled artisan will appreciate upon reading the descriptions provided herein, the above-example AR and MR systems (described in detail below) can perform various functions and/or operations.

The wrist-wearable device 426, the head-wearable devices, and/or the HIPD 442 can communicatively couple via a network 425 (e.g., cellular, near–field, Wi-Fi, personal area network, wireless LAN). Additionally, the wrist-wearable device 426, the head-wearable device, and/or the HIPD 442 can also communicatively couple with one or more servers 430, computers 440 (e.g., laptops, computers), mobile devices 450 (e.g., smartphones, tablets), and/or other electronic devices via the network 425 (e.g., cellular, near–field, Wi-Fi, personal area network, wireless LAN). Similarly, a smart textile–based garment, when used, can also communicatively couple with the wrist-wearable device 426, the head-wearable device(s), the HIPD 442, the one or more servers 430, the computers 440, the mobile devices 450, and/or other electronic devices via the network 425 to provide inputs.

Turning to FIG. 4A, a user 402 is shown wearing the wrist-wearable device 426 and the AR device 428 and having the HIPD 442 on their desk. The wrist-wearable device 426, the AR device 428, and the HIPD 442 facilitate user interaction with an AR environment. In particular, as shown by the first AR system 400a, the wrist-wearable device 426, the AR device 428, and/or the HIPD 442 cause presentation of one or more avatars 404, digital representations of contacts 406, and virtual objects 408. As discussed below, the user 402 can interact with the one or more avatars 404, digital representations of the contacts 406, and virtual objects 408 via the wrist-wearable device 426, the AR device 428, and/or the HIPD 442. In addition, the user 402 is also able to directly view physical objects in the environment, such as a physical table 429, through transparent lens(es) and waveguide(s) of the AR device 428. Alternatively, an MR device could be used in place of the AR device 428 and a similar user experience can take place, but the user would not be directly viewing physical objects in the environment, such as the table 429, and would instead be presented with a virtual reconstruction of the table 429 produced from one or more sensors of the MR device (e.g., an outward–facing camera capable of recording the surrounding environment).

The user 402 can use any of the wrist-wearable device 426, the AR device 428 (e.g., through physical inputs at the AR device and/or built-in motion tracking of a user’s extremities), a smart-textile garment, externally mounted extremity tracking device, the HIPD 442 to provide user inputs, etc. For example, the user 402 can perform one or more hand gestures that are detected by the wrist-wearable device 426 (e.g., using one or more EMG sensors and/or IMUs built into the wrist-wearable device) and/or AR device 428 (e.g., using one or more image sensors or cameras) to provide a user input. Alternatively, or additionally, the user 402 can provide a user input via one or more touch surfaces of the wrist-wearable device 426, the AR device 428, and/or the HIPD 442, and/or voice commands captured by a microphone of the wrist-wearable device 426, the AR device 428, and/or the HIPD 442. The wrist-wearable device 426, the AR device 428, and/or the HIPD 442 include an artificially intelligent digital assistant (i.e., an AI assistant) to help the user in providing a user input (e.g., completing a sequence of operations, suggesting different operations or commands, providing reminders, confirming a command). For example, the digital assistant can be invoked through an input occurring at the AR device 428 (e.g., via an input at a temple arm of the AR device 428). In some embodiments, the user 402 can provide a user input via one or more facial gestures and/or facial expressions. For example, cameras of the wrist-wearable device 426, the AR device 428, and/or the HIPD 442 can track the user 402’s eyes for navigating a user interface.

The wrist-wearable device 426, the AR device 428, and/or the HIPD 442 can operate alone or in conjunction to allow the user 402 to interact with the AR environment. In some embodiments, the HIPD 442 is configured to operate as a central hub or control center for the wrist-wearable device 426, the AR device 428, and/or another communicatively coupled device. For example, the user 402 can provide an input to interact with the AR environment at any of the wrist-wearable device 426, the AR device 428, and/or the HIPD 442, and the HIPD 442 can identify one or more back-end and front-end tasks to cause the performance of the requested interaction and distribute instructions to cause the performance of the one or more back-end and front-end tasks at the wrist-wearable device 426, the AR device 428, and/or the HIPD 442. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 442 can perform the back-end tasks and provide the wrist-wearable device 426 and/or the AR device 428 operational data corresponding to the performed back-end tasks such that the wrist-wearable device 426 and/or the AR device 428 can perform the front-end tasks. In this way, the HIPD 442, which has more computational resources and greater thermal headroom than the wrist-wearable device 426 and/or the AR device 428, performs computationally intensive tasks and reduces the computer resource utilization and/or power usage of the wrist-wearable device 426 and/or the AR device 428.

In the example shown by the first AR system 400a, the HIPD 442 identifies one or more back-end tasks and front-end tasks associated with a user request to initiate an AR video call with one or more other users (represented by the avatar 404 and the digital representation of the contact 406) and distributes instructions to cause the performance of the one or more back-end tasks and front-end tasks. In particular, the HIPD 442 performs back-end tasks for processing and/or rendering image data (and other data) associated with the AR video call and provides operational data associated with the performed back-end tasks to the AR device 428 such that the AR device 428 performs front-end tasks for presenting the AR video call (e.g., presenting the avatar 404 and the digital representation of the contact 406).

In some embodiments, the HIPD 442 can operate as a focal or anchor point for causing the presentation of information. This allows the user 402 to be generally aware of where information is presented. For example, as shown in the first AR system 400a, the avatar 404 and the digital representation of the contact 406 are presented above the HIPD 442. In particular, the HIPD 442 and the AR device 428 operate in conjunction to determine a location for presenting the avatar 404 and the digital representation of the contact 406. In some embodiments, information can be presented within a predetermined distance from the HIPD 442 (e.g., within five meters). For example, as shown in the first AR system 400a, virtual object 408 is presented on the desk some distance from the HIPD 442. Similar to the above example, the HIPD 442 and the AR device 428 can operate in conjunction to determine a location for presenting the virtual object 408. Alternatively, in some embodiments, presentation of information is not bound by the HIPD 442. More specifically, the avatar 404, the digital representation of the contact 406, and the virtual object 408 do not have to be presented within a predetermined distance of the HIPD 442. While an AR device 428 is described working with an HIPD, an MR headset can be interacted with in the same way as the AR device 428.

User inputs provided at the wrist-wearable device 426, the AR device 428, and/or the HIPD 442 are coordinated such that the user can use any device to initiate, continue, and/or complete an operation. For example, the user 402 can provide a user input to the AR device 428 to cause the AR device 428 to present the virtual object 408 and, while the virtual object 408 is presented by the AR device 428, the user 402 can provide one or more hand gestures via the wrist-wearable device 426 to interact with and/or manipulate the virtual object 408. While an AR device 428 is described working with a wrist-wearable device 426, an MR headset can be interacted with in the same way as the AR device 428.

### Integration of Artificial Intelligence with XR Systems

FIG. 4A illustrates an interaction in which an artificially intelligent virtual assistant can assist in requests made by a user 402. The AI virtual assistant can be used to complete open-ended requests made through natural language inputs by a user 402. For example, in FIG. 4A, the user 402 makes an audible request 444 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 4A also illustrates an example neural network 452 used in Artificial Intelligence (AI) applications. Uses of AI are varied and encompass many different aspects of the devices and systems described herein. AI capabilities cover a diverse range of applications and deepen interactions between the user 402 and user devices (e.g., the AR device 428, the HIPD 442, the wrist-wearable device 426). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, deep reinforcement learnings, etc. The AI models can be implemented at one or more of the user devices and/or any other devices described herein. For devices and systems herein that employ multiple AI models, different models can be used depending on the task. For example, for a natural-language artificially intelligent virtual assistant, an LLM can be used, and for the object detection of a physical environment, a DNN can be used instead.

In another example, an AI virtual assistant can include many different AI models and, based on the user’s request, multiple AI models may be employed (concurrently, sequentially or a combination thereof). For example, an LLM-based AI model can provide instructions for helping a user follow a recipe, and the instructions can be based in part on another AI model that is derived from an ANN, a DNN, an RNN, etc., that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 402 can interact with an AI model through natural language inputs captured by a voice sensor, text inputs, or any other input modality that accepts natural language and/or a corresponding voice sensor module. In another instance, input is provided by tracking the eye gaze of a user 402 via a gaze tracker module. Additionally, the AI model can also receive inputs beyond those supplied by a user 402. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors’ data can be retrieved entirely from a single device (e.g., AR device 428) or from multiple devices that are in communication with each other (e.g., a system that includes at least two of an AR device 428, the HIPD 442, the wrist-wearable device 426). The AI model can also access additional information (e.g., one or more servers 430, the computers 440, the mobile devices 450, and/or other electronic devices) via a network 425.

A non-limiting list of AI-enhanced functions includes, but is not limited to, image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 428, the HIPD 442, the wrist-wearable device 426) via one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 428, the HIPD 442, the wrist-wearable device 426), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 442), haptic feedback can provide information to the user 402. An AI model can also use the inputs described above to determine the appropriate modality and device(s) to present content to the user (e.g., a user walking on a busy road can be presented with an audio output instead of a visual output to avoid distracting the user 402).

### Example Augmented Reality Interaction

FIG. 4B shows the user 402 wearing the wrist-wearable device 426 and the AR device 428 and holding the HIPD 442. In the second XR system 400b, the wrist-wearable device 426, the AR device 428, and/or the HIPD 442 are used to receive and/or provide one or more messages to a contact of the user 402. In particular, the wrist-wearable device 426, the AR device 428, and/or the HIPD 442 detect and coordinate one or more user inputs to initiate a messaging application and prepare a response to a received message via the messaging application.

In some embodiments, the user 402 initiates, via a user input, an application on the wrist-wearable device 426, the AR device 428, and/or the HIPD 442 that causes the application to initiate on at least one device. For example, in the second XR system 400b, the user 402 performs a hand gesture associated with a command for initiating a messaging application (represented by messaging user interface 412); the wrist-wearable device 426 detects the hand gesture; and, based on a determination that the user 402 is wearing the AR device 428, causes the AR device 428 to present a messaging user interface 412 of the messaging application. The AR device 428 can present the messaging user interface 412 to the user 402 via its display (e.g., as shown by user 402’s field of view 410). In some embodiments, the application is initiated and can be run on the device (e.g., the wrist-wearable device 426, the AR device 428, and/or the HIPD 442) that detects the user input to initiate the application, and the device provides another device operational data to cause the presentation of the messaging application. For example, the wrist-wearable device 426 can detect the user input to initiate a messaging application, initiate and run the messaging application, and provide operational data to the AR device 428 and/or the HIPD 442 to cause presentation of the messaging application. Alternatively, the application can be initiated and run at a device other than the device that detected the user input. For example, the wrist-wearable device 426 can detect the hand gesture associated with initiating the messaging application and cause the HIPD 442 to run the messaging application and coordinate the presentation of the messaging application.

Further, the user 402 can provide a user input provided at the wrist-wearable device 426, the AR device 428, and/or the HIPD 442 to continue and/or complete an operation initiated at another device. For example, after initiating the messaging application via the wrist-wearable device 426 and while the AR device 428 presents the messaging user interface 412, the user 402 can provide an input at the HIPD 442 to prepare a response (e.g., shown by the swipe gesture performed on the HIPD 442). The user 402’s gestures performed on the HIPD 442 can be provided and/or displayed on another device. For example, the user 402’s swipe gestures performed on the HIPD 442 are displayed on a virtual keyboard of the messaging user interface 412 displayed by the AR device 428.

In some embodiments, the wrist-wearable device 426, the AR device 428, the HIPD 442, and/or other communicatively coupled devices can present one or more notifications to the user 402. The notification can be an indication of a new message, an incoming call, an application update, a status update, etc. The user 402 can select the notification via the wrist-wearable device 426, the AR device 428, or the HIPD 442 and cause presentation of an application or operation associated with the notification on at least one device. For example, the user 402 can receive a notification that a message was received at the wrist-wearable device 426, the AR device 428, the HIPD 442, and/or other communicatively coupled device and provide a user input at the wrist-wearable device 426, the AR device 428, and/or the HIPD 442 to review the notification, and the device detecting the user input can cause an application associated with the notification to be initiated and/or presented at the wrist-wearable device 426, the AR device 428, and/or the HIPD 442.

While the above example describes coordinated inputs used to interact with a messaging application, the skilled artisan will appreciate upon reading the descriptions that user inputs can be coordinated to interact with any number of applications, including, but not limited to, gaming applications, social media applications, camera applications, web-based applications, financial applications, etc. For example, the AR device 428 can present to the user 402 game application data, and the HIPD 442 can use a controller to provide inputs to the game. Similarly, the user 402 can use the wrist-wearable device 426 to initiate a camera of the AR device 428, and the user can use the wrist-wearable device 426, the AR device 428, and/or the HIPD 442 to manipulate the image capture (e.g., zoom in or out, apply filters) and capture image data.

While an AR device 428 is shown as being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side lens can illuminate to notify the wearer to turn left while directions are being provided. In some embodiments, the AR device can include an outward-facing projector such that information (e.g., text information, media) may be displayed on the palm of a user’s hand or other suitable surface (e.g., a table, whiteboard). In some embodiments, information may also be provided by locally dimming portions of a lens to emphasize portions of the environment in which the user’s attention should be directed. Some AR devices can present AR augments either monocularly or binocularly (e.g., an AR augment can be presented at only a single display associated with a single lens as opposed to presenting an AR augmented at both lenses to produce a binocular image). In some instances, an AR device capable of presenting AR augments binocularly can optionally display AR augments monocularly as well (e.g., for power-saving purposes or other presentation considerations). These examples are non-exhaustive, and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed-reality Interaction

Turning to FIGS. 4C-1 and 4C-2, the user 402 is shown wearing the wrist-wearable device 426 and an MR device 432 (e.g., a device capable of providing either an entirely VR experience or an MR experience that displays object(s) from a physical environment at a display of the device) and holding the HIPD 442. In the third MR system 400c, the wrist-wearable device 426, the MR device 432, and/or the HIPD 442 are used to interact within an MR environment, such as a VR game or other MR/VR application. While the MR device 432 presents a representation of a VR game (e.g., first MR game environment 420) to the user 402, the wrist-wearable device 426, the MR device 432, and/or the HIPD 442 detect and coordinate one or more user inputs to allow the user 402 to interact with the VR game.

In some embodiments, the user 402 can provide a user input via the wrist-wearable device 426, the MR device 432, and/or the HIPD 442 that causes an action in a corresponding MR environment. For example, the user 402 in the third MR system 400c (shown in FIG. 4C-1) raises the HIPD 442 to prepare for a swing in the first MR game environment 420. The MR device 432, responsive to the user 402 raising the HIPD 442, causes the MR representation of the user 422 to perform a similar action (e.g., raise a virtual object, such as a virtual sword 424). In some embodiments, each device uses respective sensor data and/or image data to detect the user input and provide an accurate representation of the user 402’s motion. For example, image sensors (e.g., SLAM cameras or other cameras) of the HIPD 442 can be used to detect a position of the HIPD 442 relative to the user 402’s body such that the virtual object can be positioned appropriately within the first MR game environment 420; sensor data from the wrist-wearable device 426 can be used to detect a velocity at which the user 402 raises the HIPD 442 such that the MR representation of the user 422 and the virtual sword 424 are synchronized with the user 402’s movements; and image sensors of the MR device 432 can be used to represent the user 402’s body, boundary conditions, or real-world objects within the first MR game environment 420.

In FIG. 4C-2, the user 402 performs a downward swing while holding the HIPD 442. The user 402’s downward swing is detected by the wrist-wearable device 426, the MR device 432, and/or the HIPD 442, and a corresponding action is performed in the first MR game environment 420. In some embodiments, the data captured by each device is used to improve the user’s experience within the MR environment. For example, sensor data of the wrist-wearable device 426 can be used to determine a speed and/or force at which the downward swing is performed, and image sensors of the HIPD 442 and/or the MR device 432 can be used to determine a location of the swing and how it should be represented in the first MR game environment 420, which, in turn, can be used as inputs for the MR environment (e.g., game mechanics, which can be used to detect speed, force, locations, and/or aspects of the user 402’s actions to classify a user’s inputs (e.g., user performs a light strike, hard strike, critical strike, glancing strike, miss) or calculate an output (e.g., amount of damage)).

FIG. 4C-2 further illustrates that a portion of the physical environment is reconstructed and displayed at a display of the MR device 432 while the MR game environment 420 is being displayed. In this instance, a reconstruction of the physical environment 446 is displayed in place of a portion of the MR game environment 420 when object(s) in the physical environment are potentially in the path of the user (e.g., a collision with the user and an object in the physical environment is likely). Thus, this example MR game environment 420 includes (i) an immersive VR portion 448 (e.g., an environment that does not have a corollary counterpart in a nearby physical environment) and (ii) a reconstruction of the physical environment 446 (e.g., table 450 and cup 452). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 426, the MR device 432, and/or the HIPD 442 are described as detecting user inputs, in some embodiments, user inputs are detected at a single device (with the single device being responsible for distributing signals to the other devices for performing the user input). For example, the HIPD 442 can operate an application for generating the first MR game environment 420 and provide the MR device 432 with corresponding data for causing the presentation of the first MR game environment 420, as well as detect the user 402’s movements (while holding the HIPD 442) to cause the performance of corresponding actions within the first MR game environment 420. Additionally or alternatively, in some embodiments, operational data (e.g., sensor data, image data, application data, device data, and/or other data) of one or more devices is provided to a single device (e.g., the HIPD 442) to process the operational data and cause respective devices to perform an action associated with processed operational data.

In some embodiments, the user 402 can wear a wrist-wearable device 426, wear an MR device 432, wear smart textile–based garments 438 (e.g., wearable haptic gloves), and/or hold an HIPD 442 device. In this embodiment, the wrist-wearable device 426, the MR device 432, and/or the smart textile–based garments 438 are used to interact within an MR environment (e.g., any AR or MR system described above in reference to FIGS. 4A–4B). While the MR device 432 presents a representation of an MR game (e.g., second MR game environment 420) to the user 402, the wrist-wearable device 426, the MR device 432, and/or the smart textile–based garments 438 detect and coordinate one or more user inputs to allow the user 402 to interact with the MR environment.

In some embodiments, the user 402 can provide a user input via the wrist-wearable device 426, an HIPD 442, the MR device 432, and/or the smart textile–based garments 438 that cause an action in a corresponding MR environment. In some embodiments, each device uses respective sensor data and/or image data to detect the user input and provide an accurate representation of the user 402’s motion. While four different input devices are shown (e.g., a wrist-wearable device 426, an MR device 432, an HIPD 442, and a smart textile–based garment 438) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile–based garment 438), sensor fusion can be utilized to ensure inputs are correct. While multiple input devices are described, it is understood that other input devices can be used in conjunction or on their own instead, such as, but not limited to, external motion-tracking cameras, other wearable devices fitted to different parts of a user, apparatuses that allow for a user to experience walking in an MR environment while remaining substantially stationary in the physical environment, etc.

As described above, the data captured by each device is used to improve the user’s experience within the MR environment. Although not shown, the smart textile–based garments 438 can be used in conjunction with an MR device and/or an HIPD 442.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments, example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices and/or a subset of components of one or more electronic devices, and facilitates communication, and/or data processing and/or data transfer between the respective electronic devices and/or electronic components.

The foregoing descriptions of FIGS. 4A–4C-2 provided above are intended to augment the description provided in reference to FIGS. 1A–3. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc., may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. An augmented-reality head-wearable system, comprising:
a first outward-facing camera configured to provide first image data for object tracking;
a second outward-facing camera configured to provide second image data for depth sensing, wherein:
the second outward-facing camera has a higher resolution than the first outward-facing camera;
the first outward-facing camera and the second outward-facing camera are configured to provide image data for processing by an artificial intelligence (AI) assistant for contextual AI usage for answering user queries directed to the AI assistant at a first point in time; and
the first outward-facing camera and the second outward-facing camera are configured to capture image data associated with a first field-of-view (FOV) of the augmented-reality head-wearable system; and
a downward-facing camera configured to capture gestures within a second FOV of the augmented-reality head-wearable system.

2. The augmented-reality head-wearable system of claim 1, wherein:
the second outward-facing camera only provides the second image data to the AI assistant upon:
receiving, from a wearer of the augmented-reality head-wearable system, a query regarding an object in the first image data; and
determining that the AI assistant cannot answer the query based on only the first image data.

3. The augmented-reality head-wearable system of claim 1, wherein a response to the user queries is generated by the AI assistant based on the second image data and one or more gestures of a wearer captured by the downward-facing camera.

4. The augmented-reality head-wearable system of claim 1, wherein one or more of the first outward-facing camera, the second outward-facing camera, and the downward-facing camera are configured to detect head and shoulder movements of a wearer of the augmented-reality head-wearable system.

5. The augmented-reality head-wearable system of claim 1, wherein the downward-facing camera is configured to track waist and chest movements of a wearer of the augmented-reality head-wearable system.

6. The augmented-reality head-wearable system of claim 1, wherein the downward-facing camera is configured to track jawline and lip movements of a wearer of the augmented-reality head-wearable system.

7. The augmented-reality head-wearable system of claim 1, wherein the downward-facing camera is communicatively coupled to one or more display projectors that cause display of an extended-reality keyboard within the second FOV based on the gestures captured by the downward-facing camera.

8. The augmented-reality head-wearable system of claim 1, wherein the downward-facing camera is a first downward-facing camera, and the augmented-reality head-wearable system further comprises:
a second downward-facing camera, wherein the first downward-facing camera has a first occlusion region corresponding to a location of the first downward-facing camera on a wearable frame of the augmented-reality head-wearable system, the second downward-facing camera has a second occlusion region corresponding to a location of the second downward-facing camera on the wearable frame, and the first downward-facing camera and the second downward-facing camera provide stereo vision coverage for the second FOV by subtracting the first occlusion region and the second occlusion region from the second FOV of the augmented-reality head-wearable system.

9. A method of assembling an augmented-reality head-wearable system, comprising:
forming an imaging system comprising:
a first outward-facing camera configured to provide first image data for object tracking;
a second outward-facing camera configured to provide second image data for depth sensing, wherein:
the second outward-facing camera has a higher resolution than the first outward-facing camera;
the first outward-facing camera and the second outward-facing camera are configured to provide image data for processing by an artificial intelligence (AI) assistant for contextual AI usage for answering user queries directed to the AI assistant at a first point in time; and
the first outward-facing camera and the second outward-facing camera are configured to capture image data associated with a first field-of-view (FOV) of the augmented-reality head-wearable system; and
a downward-facing camera configured to capture gestures within a second FOV of the augmented-reality head-wearable system.

10. The method of claim 9, wherein:
the second outward-facing camera only provides the second image data to the AI assistant upon:
receiving, from a wearer of the augmented-reality head-wearable system, a query regarding an object in the first image data; and
determining that the AI assistant cannot answer the query based on only the first image data.

11. The method of claim 9, wherein a response to the user queries is generated by the AI assistant based on the second image data and one or more gestures of a wearer captured by the downward-facing camera.

12. The method of claim 9, wherein one or more of the first outward-facing camera, the second outward-facing camera, and the downward-facing camera are configured to detect head and shoulder movements of a wearer of the augmented-reality head-wearable system.

13. The method of claim 9, wherein the downward-facing camera is communicatively coupled to one or more display projectors that cause display of an extended-reality keyboard within the second FOV based on the gestures captured by the downward-facing camera.

14. The method of claim 9, wherein the downward-facing camera is a first downward-facing camera, and the imaging system further comprises:
a second downward-facing camera, wherein the first downward-facing camera has a first occlusion region corresponding to a location of the first downward-facing camera on a wearable frame of the augmented-reality head-wearable system, the second downward-facing camera has a second occlusion region corresponding to a location of the second downward-facing camera on the wearable frame, and the first downward-facing camera and the second downward-facing camera provide stereo vision coverage for the second FOV by subtracting the first occlusion region and the second occlusion region from the second FOV of the augmented-reality head-wearable system.

15. A non-transitory computer-readable storage medium storing executable instructions, that, when executed by an augmented-reality head-wearable system that includes an apparatus and one or more processors, cause the one or more processors to perform a set of operations, including:
providing, from a first outward-facing camera, first image data for object tracking;
providing, from a second outward-facing camera, second image data for depth sensing, wherein:
the second outward-facing camera has a higher resolution than the first outward-facing camera;
the first outward-facing camera and the second outward-facing camera are configured to provide image data for processing by an artificial intelligence (AI) assistant for contextual AI usage for answering user queries directed to the AI assistant at a first point in time; and
the first outward-facing camera and the second outward-facing camera are configured to capture image data associated with a first field-of-view (FOV) of the augmented-reality head-wearable system; and
capturing, from a downward-facing camera, gestures within a second FOV of the augmented-reality head-wearable system.

16. The non-transitory computer-readable storage medium of claim 15, wherein:
the second outward-facing camera only provides second image data to the AI assistant upon:
receiving, from a wearer of the augmented-reality head-wearable system, a query regarding an object in the first image data; and
determining that the AI assistant cannot answer the query based on only the first image data.

17. The non-transitory computer-readable storage medium of claim 15, wherein a response to the user queries is generated by the AI assistant based on the second image data and one or more gestures of a wearer captured by the downward-facing camera.

18. The non-transitory computer-readable storage medium of claim 15, wherein one or more of the first outward-facing camera, the second outward-facing camera, and the downward-facing camera are configured to detect head and shoulder movements of a wearer of the augmented-reality head-wearable system.

19. The non-transitory computer-readable storage medium of claim 15, wherein the downward-facing camera is communicatively coupled to one or more display projectors that cause display of an extended-reality keyboard within the second FOV based on the gestures captured by the downward-facing camera.

20. The non-transitory computer-readable storage medium of claim 15, wherein the downward-facing camera is a first downward-facing camera, and the augmented-reality head-wearable system further comprises:
a second downward-facing camera, wherein the first downward-facing camera has a first occlusion region corresponding to a location of the first downward-facing camera on a wearable frame of the augmented-reality head-wearable system, the second downward-facing camera has a second occlusion region corresponding to a location of the second downward-facing camera on the wearable frame, and the first downward-facing camera and the second downward-facing camera provide stereo vision coverage for the second FOV by subtracting the first occlusion region and the second occlusion region from the second FOV of the augmented-reality head-wearable system.
